(19) United States
(12) Patent Application Publication
(10) Pub. No.: US 2009/0144773 A1
(43) Pub. Date: Jun. 4, 2009

(54) Systems and Methods for Segmenting Electronic Program Guide Information

(75) Inventors: Mike Cavanaugh, Englewood, CO (US); David A. Kummer, Highlands Ranch, CO (US)

Correspondence Address: EchoStar Technologies, L.L.C., c/o Dorsey & Whitney LLP, 370 Seventeenth St, Suite 4700, Denver, CO, 80202, US

(73) Assignee: EchoStar Technologies L.L.C, Englewood, CO (US)

(21) Appl. No.: 12/324,487

(22) Filed: Nov. 26, 2008

Related U.S. Application Data
(60) Provisional application No. 60/991,321, filed on Nov. 30, 2007.

(51) Int. Cl. H04N 5/445; H04N 7/20

(52) U.S. Cl. 725/44; 725/71

(57) ABSTRACT

An approach to providing EPG information segments the EPG information into a plurality of segmented EPGs, i.e., subsets of the EPG information. The EPG information for all channels may be segmented into EPGs for separate local channels, i.e., channels received by client devices within a particular geographical region or broadcast area, and a “home” or universal EPG. Alternatively or additionally, the EPG information for all channels may be segmented into EPGs, for example, based on channel content or category.

### CROSS REFERENCE TO RELATED APPLICATION

The present application claims the benefit under 35 U.S.C. §119(e) to U.S. Provisional Patent Application No. 60/991,321, which was filed on Nov. 30, 2007, and entitled “SYSTEMS AND METHODS FOR SEGMENTING ELECTRONIC PROGRAM GUIDE INFORMATION,” which is incorporated by reference into the present application in its entirety.

### TECHNICAL FIELD

The inventive field relates generally to electronic program guide (EPG) information. More specifically, the inventive field relates to transmission of EPG information.

### BACKGROUND DISCUSSION

The proliferation of subscription television programming, the increasing number of available channels, and the corresponding increase in television programming have led to continued development of onscreen program directories and guides. Such onscreen programming solutions, collectively referred to herein as electronic program guides, have ranged from program information for each channel scrolling vertically across the screen to user controllable interfaces that allow users to examine scheduling information describing television programs to be broadcast in the future.

In direct broadcast satellite (DBS) systems, EPG information is periodically downloaded and updated, usually at regular intervals, at client devices. Currently, a “home” or universal EPG comprising EPG information for all channels, including over-the-air (OTA) channels, is provided as a single file or transmission to all client devices of the DBS system. This may cover, for example, a nine-day period as supported by local storage at the client devices and available bandwidth for transmission. Additionally, EPG information for a shorter period of time, such as two days, may be provided that includes only satellite channels, for example. Further, a minimal amount of program information may be provided as an event information table (EIT), for example, on all transponders to provide current and next program information, without needing to update the universal EPG.

### SUMMARY

The “home” or universal EPG is currently a relatively large amount of data, on the order of 100 megabites. This generally requires a relatively large bandwidth for transmission of the universal EPG. Further, at a transmission rate of four megabits per second, significant delays may occur at the client devices while downloading and updating EPG information. These issues are expected to become more burdensome and impractical as the number of available channels continues to increase.

An approach to providing EPG information is disclosed herein that segments the EPG information into a plurality of segmented EPGs, i.e., subsets of the EPG information. Various approaches to such segmentation are contemplated.

For example, the EPG information for all channels may be segmented into EPGs for separate local channels, i.e., channels received by client devices within a particular geographical region or broadcast area, and a “home” or universal EPG. The size, i.e., amount of data, of the universal EPG may thus be reduced from that currently employed. The segmented EPGs for local channels may be separately transmitted or otherwise provided to corresponding client devices, for example, using the corresponding transponders that provide the local channels to the client devices. The universal EPG may be separately transmitted to all client devices via a separate transponder. As such, the bandwidth and/or time required for transmission of the segmented EPGs may be reduced, as compared to that required for transmission of the EPG information for all channels together.

The EPG information for all channels may also be segmented into EPGs, for example, based on channel content or category. For example, most popular channels, e.g., channels providing the most popular content or most viewed and/or recorded channels, may be included in the universal EPG, while other channels providing less popular content may be segmented into one or more separate EPGs. In other words, the EPG information for all channels may be segmented into the universal EPG, including EPG information regarding popular channels, and additional EPGs for other channels based on content or category, such as international channels, religious channels, etc.

Various embodiments may provide a method of segmenting EPG information. The method may include the operations of: providing EPG information; segmenting the EPG information into a plurality of EPGs. In some embodiments, segmenting the EPG information may comprise segmenting the EPG information into a universal EPG and a plurality of local EPGs. In such embodiments, the local EPGs may only include EPG information for channels to be received by a particular subset of client devices, such as a region or broadcast area, and the universal EPG may only include EPG information for channels to be received by all client devices.

In some embodiments, segmenting the EPG information may comprise segmenting the EPG information into a universal EPG and at least one other EPG based on content of channels. In such embodiments, the universal EPG may only include EPG information regarding channels that provide relatively popular content. The at least one other EPG may only include EPG information regarding channels that provide relatively less popular content. In some embodiments, the at least one other EPG may comprise a plurality of EPGs segmented based on content and/or category.

Some embodiments may provide a method of transmitting EPG information. The method may include the operations of: transmitting EPG information to a plurality of client devices by transmitting a first EPG to the plurality of client devices; and transmitting a second EPG to a subset of the plurality of client devices. In some embodiments, the first EPG may be a universal EPG and the second EPG may be a local EPG. In some embodiments, the EPG information may be segmented into the first and second EPGs based on channel content and/or category.

Some embodiments may take the form of a system for transmitting EPG information. The system may include: a source of EPG information that is segmented into a plurality of segmented EPGs; and a transmission controller configured to separately transmit the segmented EPGs. In some embodiments, the system may further comprise at least one satellite including a plurality of transponders. In such embodiments, the transmission controller may be configured to transmit each of the segmented EPGs via a separate one of the plurality of transponders. In some embodiments, the system may further comprise a plurality of satellites. In such embodiments, the transmission controller may be configured to transmit different ones of the segmented EPGs via different ones of the plurality of satellites.

Some embodiments may take the form of a computer readable storage medium. The computer readable storage medium may include instructions for carrying out the operations of the methods described herein and/or for implementing the systems described herein.

### BRIEF DESCRIPTION OF THE DRAWINGS

Various details of the present invention may be better understood on reading the following detailed description of non-limiting embodiments, and on examining the accompanying drawings.

FIG. 1 is a block diagram illustrating an example of a configuration for satellite broadcast of television programming.

FIG. 2 is a conceptual representation of transponders for transmitting satellite television signals and segmented EPG information.

FIG. 3 is a block diagram illustrating an example of a system configured to transmit segmented EPG information.

FIG. 4 is a flowchart illustrating an example of operations for segmenting EPG information.

FIG. 5 is a flowchart illustrating an example of operations for transmitting segmented EPG information.

### DETAILED DESCRIPTION OF EMBODIMENTS

As used herein, the term “client device” encompasses a device that is configured to receive programs and/or program information from a broadcast source and to facilitate display of the programs and/or the program information on a display device, such as a television or a monitor. Although not restricted to a particular implementation, the term “client device” is intended to encompass set top boxes, satellite receivers, digital video recorders, and the like. The client devices described herein may be embodied in software and/or hardware that facilitate the reception and display of programs and/or program information from a broadcast source of any suitable type (e.g., satellite, Internet protocol, wireless, etc.).

The embodiments shown in the figures illustrate systems and methods that may allow segmentation of EPG information. The illustrated systems and methods provide examples of how such segmentation may be implemented. However, it should be understood that other implementations are possible and contemplated.

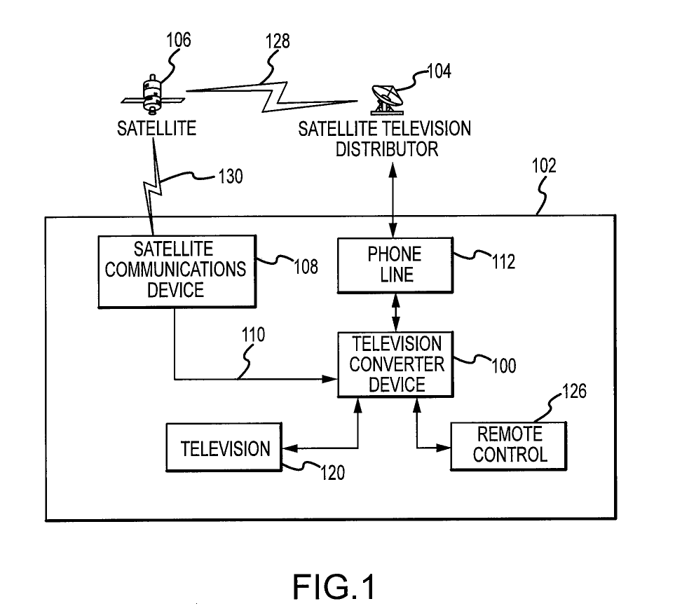

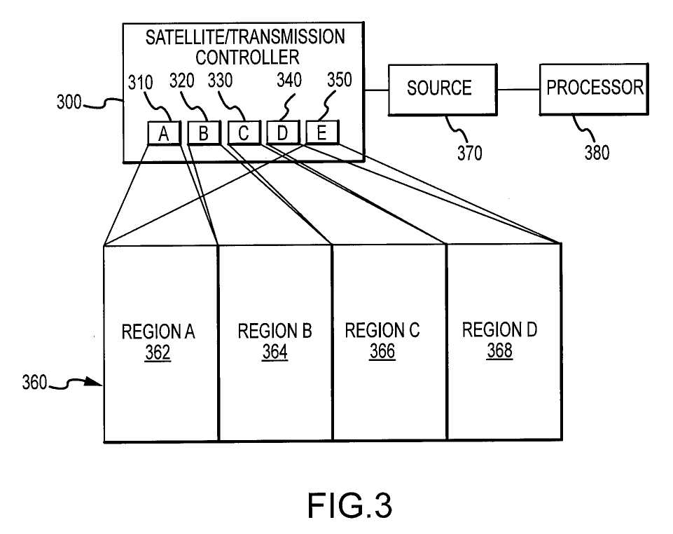

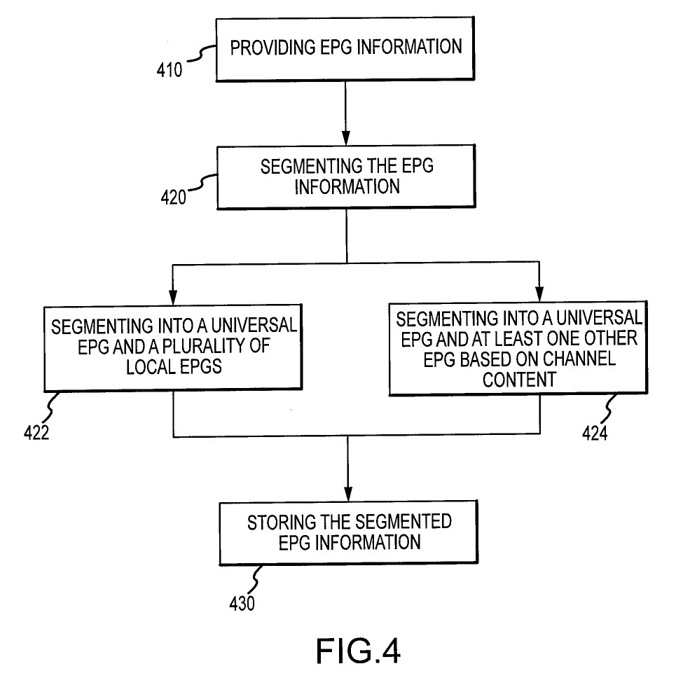

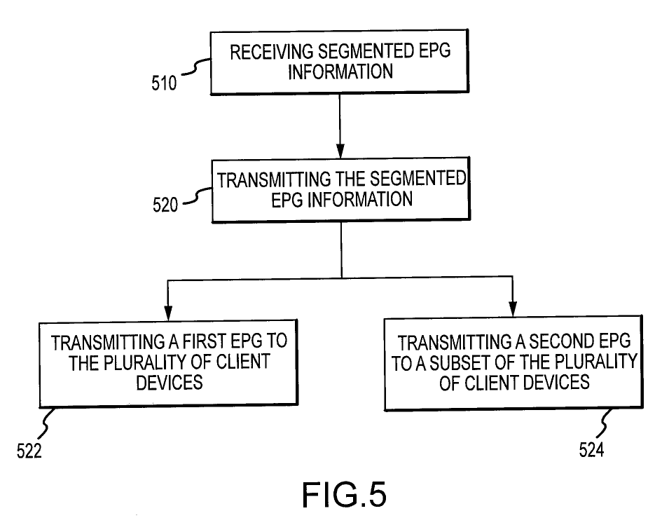

The block diagrams shown in FIGS. 1 and 3, and the flowcharts shown in FIGS. 4 and 5, are for illustration only and are not intended to represent the only possible methods and system configurations. In particular, it should be understood that method operations may be added, omitted and reordered as may be suitable to a particular application or embodiment. Also, individual components may be added, omitted, replaced and interrelated as may be suitable to a particular application. All details appurtenant to implementing the exemplary processes and systems that are well understood in the art are omitted for simplicity and clarity.

The disclosure provided herein is in terms of methods and systems related to subscriber satellite television service. This detailed description is not meant to limit the disclosure to any specific embodiment. The disclosure may also be applicable to cable television systems, broadcast television systems or other television or video distribution systems. The disclosure is also provided in terms of digital video recorder (DVR) devices. However, the disclosure may also be applicable to other client devices, such as televisions, set top boxes or other similar devices.

As a general matter, the disclosure uses the term “signal,” which may be any digital or analog signal, and may include, but are not limited to, a bit, a specified set of bits, an A/C signal, or a D/C signal. It should also be understood that the terms “transmit” and “transmission” are not limited to a particular mode, but are considered to encompass any manner of conveyance or communication of data between two devices.

Finally, as a general matter, it should be understood that satellite television signals may be very different from broadcast television or other types of signals. Satellite signals may include multiplexed, packetized, and modulated digital signals. Once multiplexed, packetized and modulated, one satellite transponder may carry digital data representing several television stations or service providers. Some examples of service providers include HBO™, CSPAN™, ABC™, CBS™, or ESPN™. In satellite television, a service provider can also be compared to a “channel.”

The term “channel,” as used in this description, carries a different meaning from its normal connotation. In broadcast television, different analog signals of a television station may be carried on a carrier frequency and its sub-channels. A tuner in a television may then acquire and process these signals. In broadcast television, the term channel has thus become synonymous with the sub-channel or the station on that sub-channel. The normal connotation of the term “channel” is therefore not always appropriate to describe satellite television transmissions where multiple stations may be multiplexed onto a single carrier frequency. Satellite television distributors, however, may organize the satellite data into a group of different “virtual channels.” These virtual channels give the impression that the satellite television programs (the service providers) are placed in channels. This impression may assist user operation of the satellite set-top-box since it models an analog television or analog receiving device. The virtual channels may appear in the EPG data and the user may choose programming by selecting a virtual channel. For instance, the user may select HBO™, which may be one virtual channel, or CSPAN™, which may be on another virtual channel. These service providers or virtual channels are not necessarily carried in the same signal being sent from the same satellite. EPG data may come from a service provider (e.g., HBO™), content provider (e.g., Disney™), a third party (e.g., TV Guide™) or from another outside entity. Thus, in satellite television service a channel may not be the same as in broadcast television service. Rather, channels may be more properly termed service providers in satellite television service. The term “channel” will be used in this description to describe the service providers and the virtual channels they may occupy.

A configuration for satellite broadcast of television programming is illustrated in FIG. 1. As shown, a residential system 102 may include a television converter device 100, in the form of a set-top-box, a digital video recorder, or other client device. Generally, the client device 100 may receive one or more television signals from a cable television distributor, from a broadcast television distributor or from a satellite television distributor 104, as shown. The client device 100 may also receive video-digital subscriber line (DSL), DSL, Internet, wireless and other signals from content or video distributors. The client device 100 may process television signals and may send the processed signals to peripheral electronic devices, such as a television 120. The client device 100 also may accept commands from a remote control 126 or other peripheral electronic devices. It should be understood that the residential system 102 may be of any desired configuration and is not limited to the configuration illustrated.

The satellite television distributor 104 may transmit one or more satellite television signals 128 to one or more satellites 106. Satellite television distributors may utilize several satellites 106 to relay the satellite television signals to a subscriber. Each satellite 106 may include several transponders. Each transponder may transmit a signal 130 from the satellite 106 to the subscriber (i.e., the residential system 102).

The signals may be received at a satellite communication device 108. The satellite communication device 108 may comprise a satellite dish. A satellite dish may focus the signal on one or more low-noise block filters (LNBF), also referred to as low-noise block down converters (LNBDC). The LNBFs may convert and/or initially process the signal. This initial processing may include filtering noise from the signal and down-converting the signal. Down-conversion is sometimes required to transmit a signal 110 through certain cables, such as coaxial cables. The signal 110 may arrive at the client device 100, for example, via cabling.

Another peripheral device and connection to the client device 100 may include a phone line and modem. The client device 100 may use a modem and phone line to communicate with one or more outside entities or systems (e.g., the satellite television distributor 104). The phone line may carry local or long-distance telephone service, DSL service, etc. Communications may include requesting pay-per-view programming, reporting of purchases (for example, pay-per-view purchases), obtaining updates to subscriber programming (e.g., updating EPG data), or receiving updates to software on the satellite set-top-box 100. It should be understood that EPG data may be transmitted to the client device 100 via the phone line 112 or in the satellite signal 130. Further it should be understood that a phone line connection to the satellite distributor 104 may represent other communication connections, including, but not limited to, wireless, Internet, or microwave communications connections. Also, a phone line connection may permit networked communications with other network-ready devices using the telephone wiring within a subscriber's location.

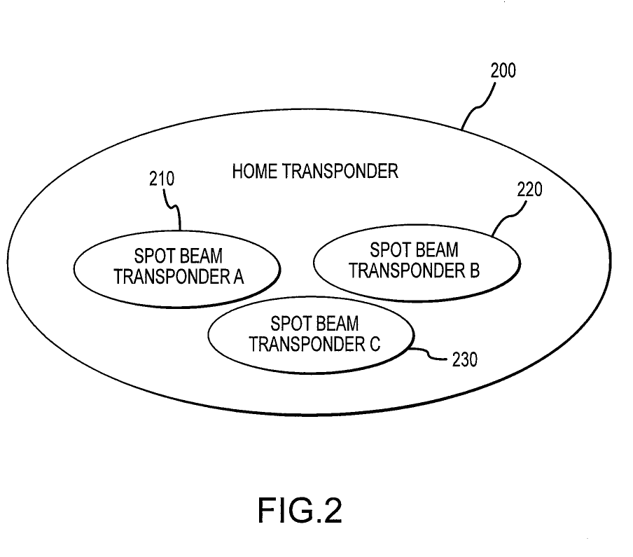

A conceptual representation of transponders for transmitting satellite television signals is illustrated in FIG. 2. As discussed above, a satellite may include a plurality of transponders. Each transponder may be configured to transmit a plurality of channels. Further, each transponder may be configured to transmit to a particular coverage area. For example, a home transponder may be configured to transmit to an entire broadcast area 200, and spot beam transponders A, B, C may be configured to transmit to specific regions 210, 220, 230 within the broadcast area 200. As an example, the home transponder may provide a wide beam to cover the continental United States (CONUS) as the entire broadcast area 200. The spot beam transponders A, B, C may provide a narrow beam to cover time zones (EST, CST, MST/PST) as the specific regions 210, 220, 230 within the continental United States (CONUS).

As discussed above, EPG information for all available channels is currently transmitted as a single file or transmission to all client devices of the television distribution system. However, as also discussed above, this “home” or universal EPG is currently a relatively large amount of data, on the order of 100 megabytes, which is expected to increase as the number of available channels continues to increase.

This disclosure contemplates approaches to dealing with the currently and increasing large amount of data comprising EPG information that involve segmenting the EPG information into a plurality of segmented EPGs, i.e., subsets of the EPG information. For example, the EPG information for all channels may be segmented into local EPGs for separate local channels, i.e., channels received by client devices within a particular geographical region or broadcast area, and a “home” or universal EPG.

With reference to the conceptual representation of transponders shown in FIG. 2, each of the local EPGs may be transmitted with the signals for the local channels by the spot beam transponders A, B and C, respectively. Thus, the local EPG corresponding to the local channels for the particular region/area may be transmitted only to that region/area. The universal EPG, containing EPG information for the remaining channels once the local channel EPG information is separated by segmentation, may be transmitted with the signals for the remaining channels by the home transponder. Thus, the universal EPG corresponding to channels for all regions/areas may be transmitted to all regions/areas. The size, i.e., amount of data, of each EPG transmission may thus be reduced. This may improve the efficiency of EPG transmissions and may reduce or minimize delays that might otherwise occur at the client devices during downloading of EPG information, for example.

A block diagram illustrating this approach is shown in FIG. 3. A satellite or transmission controller 300 may be configured to transmit EPG information via a plurality of transponders 310, 320, 330, 340, 350. In this example, the transponders 310, 320, 330, 340 may be spot beam transponders configured to cover a particular area or region, and the transponder 350 may be a home transponder configured to provide wide coverage, e.g., covering an entire broadcast area of the satellite 300 or the television broadcast system of which the satellite 300 is part.

As illustrated in FIG. 3, the transponders 310, 320, 330, 340 may be configured to transmit signals to regions A-D 362, 364, 366, 368, respectively, and the transponder 350 may be configured to transmit signals to an area 360 encompassing the regions 362, 364, 366, 368. Accordingly, the transponder 350 may transmit all non-local channels and the home or universal EPG, segmented to include EPG information regarding only those channels, to all of the regions 362, 364, 366, 368. The transponder 310 may transmit local channels for region A and a local EPG, segmented to include EPG information regarding only the local channels for region A, to region A 362. The transponder 320 may transmit local channels for region B and a local EPG, segmented to include EPG information regarding only the local channels for region B, to region A 364. The transponder 330 may transmit local channels for region C and a local EPG, segmented to include EPG information regarding only the local channels for region C, to region A 366. The transponder 340 may transmit local channels for region D and a local EPG, segmented to include EPG information regarding only the local channels for region D, to region A 368.

The satellite or transmission controller 300 may include or may be configured to communicate with a source 370 of segmented EPG information. The source 370 of EPG information may be a set of data files, a set of data tables, a database of such files or tables, or any other suitable arrangement for making a plurality of EPGs available for transmission by the satellite or transmission controller 300. The source 370 may be populated with segmented EPG information, for example, by a processor 380 that is configured to segment EPG information.

The processor 380 may be configured to operate in any suitable manner. For example, if EPG information is provided on a per channel basis, e.g., separate data files for each channel, the processor 380 may be configured to assemble the EPG information into a plurality of EPGs by making various combinations of the EPG information regarding specific channels (e.g., combinations of the data files or the data from the data files). If EPG information is provided as a database, the processor 380 may be configured to retrieve or extract EPG information regarding specific channels to generate a plurality of EPGs. In general, EPG information may be received from a variety of sources and stored in a database, for example, at a satellite uplink center. The received EPG information may be processed and added to the database. Further, the EPG information may be organized as channels and/or grouped within the database. The organization and/or grouping may be based on logic or rules in the processor. The EPG information may be assigned to particular segment(s) as well. For example, the EPG information may be grouped in categories of channels, such as local, high definition, pay-per-view, etc., which may correspond to the desired segmentation, as discussed herein.

In general, the spot beam transponders may be configured to transmit only EPG information regarding the channels transmitted by the respective spot beam transponder, and the home transponder may be configured to transmit only EPG information regarding the remaining channels, i.e., those not transmitted by the spot beam transponders. Thus, segmentation of the EPG information may be performed on any suitable basis, in addition to or as an alternative to a local channel basis. For example, the EPG information for all channels may be segmented into EPGs, for example, based on channel content or category.

In some embodiments, EPG information regarding the most popular channels, e.g., channels providing the most popular content or most viewed and/or recorded channels, may be included in the universal EPG. Because these channels are more likely to be received in all areas or regions, or even by all client devices, the EPG information regarding these channels is more likely to be relevant or needed for all areas, regions or client devices. EPG information regarding the other channels providing less popular content may be segmented into one or more separate EPGs and transmitted separately. The separate EPGs may be transmitted via spot beam transponders or via a wide coverage area transponder similar to the home or universal transponder. In case of the latter, segmenting the EPG information still reduces the size of the universal EPG to be received by all client devices, and allows only client devices that receive less popular channels to receive and download the EPG information regarding those channels. In other words, each client device may be configured to receive and download the segmented universal EPG as well as any other segmented EPGs for channels the client device is configured to receive.

Segmentation based on content and/or category is not limited to popularity of channels. Content or categories such as international channels, religious channels, high definition channels, business channels, and the like may be used. Segmentation may also be based on the location (e.g., orbital position) of satellites. This may allow the EPG information to be segmented according to the client devices that receive EPG information from the particular satellites, for example. Other basis for segmentation may include language, such as programs in Spanish, or theme, such as movies, sports, etc. As discussed above, channels with the particular content or within the particular category may be transmitted via particular transponder(s), and a segmented EPG or EPGs may be transmitted via the corresponding transponders.

Various methods of segmenting EPG information may be envisioned based on the foregoing description. In general, a method of segmenting EPG information may include the operations illustrated in FIG. 4. First, an operation 410 of providing EPG information may be performed. The EPG information may be provided in any suitable form, for example, that may be processed for database storage. In addition to any known or hereafter developed database format, flat file or XML formats may also be employed. Next an operation 420 of segmenting the EPG information, for example, into a plurality of EPGs may be performed. Any suitable technique may be employed to segment the EPG information. In particular, the operation 420 may include an operation 422 of segmenting the EPG information into a universal EPG and a plurality of local EPGs and/or an operation 424 of segmenting the EPG information into a universal EPG and at least one other EPG based on content of channels. Once the EPG information has been segmented, an operation 430 of storing the segmented EPG information, for example, as a plurality of segmented EPGs. It should be understood that the EPG information may be segmented without actually generating the EPGs, and stored in a manner that allows the EPGs to be generated later.

Various methods of transmitting segmented EPG information may be envisioned based on the foregoing description. In general, a method of transmitting segmented EPG information may include the operations illustrated in FIG. 5. First, an operation 510 of receiving segmented EPG information may be performed. As discussed above, the EPG information may be received in any suitable form. Next an operation 520 of transmitting EPG information to a plurality of client devices as a plurality of EPGs may be performed. Any suitable technique may be employed to transmit the plurality of EPGs. In particular, the operation 520 may include an operation 522 of transmitting a first EPG to the plurality of client devices and an operation 524 of transmitting a second EPG to a subset of the plurality of client devices. In some embodiments, the operation 524 may comprise transmitting the second EPG to all of the plurality of client devices, for example, wherein only some (i.e., a subset) of the client devices are configured to receive and download the second EPG.

It should be understood that each of the foregoing operations may be optional for a given implementation and that the various operations may be combined, as appropriate or desired.

The logical operations of various embodiments contemplated may be implemented as (1) a sequence of computer implemented acts or program modules running on a computing system and/or (2) as interconnected machine logic circuits or circuit modules within the computing system. The implementation may be a matter of choice dependent on the performance requirements of the computing system used for implementation. Accordingly, the logical operations may be referred to variously as operations, structural devices, acts or modules. It should be understood that these operations, structural devices, acts and modules may be implemented in software, in firmware, in special purpose digital logic, and any combination thereof.

In particular, as noted above, some embodiments may take the form of a computer readable storage medium. The computer readable storage medium may include instructions for carrying out the operations of the methods described above and/or for implementing the systems and approaches described above. Computer storage media include volatile and nonvolatile, removable and non-removable media implemented in any method or technology for storage of information such as computer readable instructions, data structures, program modules or other data. Computer storage media include, but are not limited to, RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium that may be used to store information and may be accessed by a computer.

Although various details have been described herein with reference to particular embodiments, it is to be understood that these embodiments are merely illustrative of principles and applications. It is therefore to be understood that numerous modifications may be made to the illustrative embodiments and that other arrangements may be devised without departing from the spirit and scope of this disclosure.

What is claimed is:

1. A method of providing electronic program guide information, the method comprising:
providing electronic program guide information regarding a plurality of television channels to be distributed;
segmenting, at a headend of a television service provider, the electronic program guide information into a plurality of segmented electronic program guides based on channel; and
transmitting the segmented electronic program guides from the headend to a plurality of client television receiver devices.

2. The method of claim 1, wherein segmenting the electronic program guide information comprises segmenting the electronic program guide information into a universal electronic program guide and a plurality of subset electronic program guides each including electronic program guide information only for a subset of the television channels.

3. The method of claim 2, wherein the subsets of the television channels comprise local channels for different regions.

4. The method of claim 2, wherein transmitting the segmented electronic program guides comprises separately and selectively transmitting the plurality of subset electronic program guides to respective ones of the plurality of client television receiver devices.

5. The method of claim 2, wherein transmitting the segmented electronic program guides comprises separately transmitting the universal electronic program guide and the plurality of subset electronic program guides.

6. The method of claim 5, wherein transmitting the plurality of subset electronic program guides comprises separately and selectively transmitting the plurality of subset electronic program guides to respective ones of the plurality of client television receiver devices.

7. The method of claim 2, wherein segmenting the electronic program guide information into the universal electronic program guide comprises segmenting the electronic program guide information based on a measure of popularity of the television channels.

8. The method of claim 7, wherein segmenting the electronic program guide information into the plurality of subset electronic program guides comprises segmenting the electronic program guide information based on content of the television channels.

9. The method of claim 7, wherein segmenting the electronic program guide information into the plurality of subset electronic program guides comprises segmenting the electronic program guide information based on category of the television channels.

10. The method of claim 2, wherein segmenting the electronic program guide information into the plurality of subset electronic program guides comprises segmenting the electronic program guide information based on content of the television channels.

11. The method of claim 2, wherein segmenting the electronic program guide information into the plurality of subset electronic program guides comprises segmenting the electronic program guide information based on category of the television channels.

12. A method of providing electronic program guide information, the method comprising:
providing electronic program guide information regarding a plurality of television channels to be distributed;
segmenting, at a headend of a television service provider, the electronic program guide information into a universal electronic program guide and at least one other electronic program guide based on at least one of content and category of the television channels; and
transmitting the universal electronic program guide and the at least one other electronic program guide from the headend to a plurality of client television receiver devices.

13. The method of claim 12, wherein segmenting the electronic program guide information comprises segmenting based on a measure of popularity of the content and/or category of the television channels.

14. The method of claim 13, wherein segmenting the electronic program guide information comprises including electronic program guide information regarding ones of the television channels with a relatively high measure of popularity in the universal electronic program guide and segmenting electronic program guide information regarding a remainder of the television channels into a plurality of other the electronic program guides.

15. The method of claim 14, wherein segmenting electronic program guide information regarding the remainder of the television channels into the plurality of other the electronic program guides is based on content of the remainder of the television channels.

16. The method of claim 14, wherein segmenting electronic program guide information regarding the remainder of the television channels into the plurality of other the electronic program guides is based on category of the remainder of the television channels.

17. A method of providing electronic program guide information, the method comprising:
providing electronic program guide information regarding a plurality of television channels to be distributed;
segmenting, at a headend of a television service provider, the electronic program guide information into a plurality of segmented electronic program guides, the plurality of segmented electronic program guides including a universal electronic program guide including electronic program guide information for television channels to be received by all of the client television receiver devices and a plurality of local electronic program guides each including electronic program guide information for only television channels to be received a particular subset of the client television receiver devices; and
transmitting the plurality of segmented electronic program guides from the headend to a plurality of client television receiver devices.

18. The method of claim 17, wherein transmitting the plurality of segmented electronic program guides comprises:
transmitting a first of the local electronic program guides to a first subset of the plurality of client television receiver devices; and
transmitting a second of the local electronic program guides to a second subset of the plurality of client television receiver devices.

19. The method of claim 17, wherein transmitting the plurality of segmented electronic program guides comprises:
transmitting a first portion of the electronic program guide information to all of the plurality of client television receiver devices;
transmitting a different second portion of the electronic program guide information to a first subset of the plurality of client television receiver devices; and
transmitting a different third portion of the electronic program guide information to a different second subset of the plurality of client television receiver devices.

20. The method of claim 19, wherein transmitting the second portion of the electronic program guide information to the first subset is performed using a first spot beam transmitted from a satellite, and transmitting the third portion of the electronic program guide information to the second subset is performed using a different second spot beam transmitted from the satellite.
